(19) United States
(12) Patent Application Publication
(10) Pub. No.: US 2003/0154212 A1
(43) Pub. Date: Aug. 14, 2003

(54) Method and apparatus for determining attributes among objects

(75) Inventors: Andrew L. Schirmer, Andover, MA (US); Marijane M. Zeller, Medford, MA (US)

Correspondence Address: KUDIRKA & JOBSE, LLP, ONE STATE STREET, SUITE 1510, BOSTON, MA, 02109, US

(73) Assignee: International Business Machines Corporation, Armonk, NY

(21) Appl. No.: 10/352,500

(22) Filed: Jan. 28, 2003

Related U.S. Application Data
(60) Provisional application No. 60/352,368, filed on Jan. 28, 2002.

(51) Int. Cl. G06F 7/00

(52) U.S. Cl. 707/103 R

(57) ABSTRACT

An aggregation system performs an aggregation of object attributes and affinities to create a group profile of a plurality of object profiles. The system may be used with an electronic mail inbox that uses a mail agent to categorize incoming electronic mail to facilitate more flexible and rapid review of special types of mail, such as meeting requests. The aggregation system performs an analysis of the participants listed in a meeting request and displays an aggregated profile that provides a “big picture” view of the attributes of the group members as a single entity, thereby enabling the user to get an immediate sense of a group's areas of expertise. The aggregation system may also suggest additional participants with the needed expertise which the user may ignore or invite by simply mailing the meeting request thread thereto.

### RELATED APPLICATIONS

This non-provisional application claims priority to commonly assigned U.S. provisional application Serial No. 60/352,368, filed Jan. 28, 2002, Attorney Docket No. L0006/7068V1, by Andrew L. Schirmer, entitled “Method and Apparatus for Determining Attributes Among Objects.”

### FIELD OF THE INVENTION

This invention relates, generally, to data processing systems and, more specifically, to a technique for aggregating information about the properties of individual objects into a group object.

### BACKGROUND OF THE INVENTION

Electronic mail has become one of the most widely used business productivity application. The content and use of email has also changed. In addition to traditional letters, email now consists of invitations, receipts, transactions, discussions, conversations, tasks, and newsletters, to name a few variations. With the advent collaborative meeting applications, such as Lotus Sametime, commercially available from International Business Machines Corporation, Cambridge, Mass., it is possible to arrange virtual meeting between remotely located users. These meeting may be arranged via electronic mail. However, within large organizations it is sometimes difficult to determine the proper participants to a meeting, virtual or otherwise. This problem become more acute when the participant are not familiar with each other. It would be valuable to get a “big picture” of the group of meeting participants to determine where they are and what they know, i.e. what affinities they have. Such a group profile would assistant in evaluating the group as a whole, instead of on an individual by individual basis. The concept of a group profile could also be of a benefit in any circumstance in which a collection of entities, such as objects having attributes, has parameters that can be aggregated into a collective profile representing the collective characteristics of the group.

Accordingly a need exists for a system that can determine from an existing group of participants whether a weakness or deficiency in a particular skill exists among the group.

A further need exists for a system that can automatically or manually enable aggregation of information about the properties of individual objects into a group object.

### SUMMARY OF THE INVENTION

An aggregation system performs an aggregation of object attributes and affinities to create a group profile of a plurality of object profiles. The system may be used with an electronic mail inbox uses a mail agent to categorize incoming electronic mail to facilitate more flexible and rapid review of special types of mail, such as meeting requests. The aggregation system performs an analysis of the participants listed in a meeting request and displays an aggregated profile that provides a “big picture” view of the attributes of the group members as a single entity, thereby enabling the user to get an immediate sense of group's areas of expertise. The aggregation system may also suggest additional participants with the needed expertise who the user may ignore or invite by simply mailing the meeting request thread thereto.

The aggregated profile easily provides a view of the attributes of the group members as a single entity unto itself. With a location property, for example, the user of the aggregate gets an immediate sense of where the group “is.” For areas of expertise, for example, the user sees what the group “knows.” Aggregations may be selected automatically by the system, or manually by system users, but in either case, the system uses its knowledge about the types of data to be aggregated to produce the described result.

The inventive aggregation system contains user profiles, which contain information, or properties, about individual people. Examples include name, title, e-mail address, telephone numbers, etc. User profiles may be stored in a server application, such as the Lotus Discovery Server, and may further include information about people's affinities, which indicate a connection between the person and some category of information. Affinities can be created in various ways including calculated automatically using a weighing algorithm, or declared by the individual, or designated by third party(s).

Aggregations may be selected automatically by the system, or manually by system users, but in either case, the system uses its knowledge about the types of data to be aggregated to produce the described result. In the illustrative embodiment, the inventive system contains user profiles, which contain information, or properties, about individual people. Examples may include name, title, e-mail address, telephone numbers, etc. User profiles may be stored in a Lotus server application, designated hereafter as a Discovery Server, and may further include information about people's affinities, which indicate a connection between the person and some category of information, such as marketing, sales, manufacturing, etc. Affinities can be created in various ways including calculated automatically using a weighing algorithm, or declared by the individual, or designated by third party(s).

In the Discovery Server, profiles may be created automatically from one or more sources of information about people. The title may be from one data source, the address from another, and so on. In such an embodiment that aggregates information automatically—i.e. the system chooses which objects to aggregate—there are also one or more objects that express information about groups of people. In Lotus Notes, for example, there are Group objects that control electronic mail mailing lists, database access, and so forth. The system also allows aggregates to be created manually—i.e. users of the system choose which objects to aggregate. In both cases, the aggregation system itself contains the knowledge about how to perform the aggregation, and how to display the results. The difference between automatic and manual versions has only to do with the way objects are chosen for aggregation.

Once the set of objects for aggregation has been chosen, the system uses a set of aggregators to combine the like properties from the chosen profiles into the aggregated property. The types of aggregation depend on the types of properties being aggregated. Text properties may be compiled into lists. For example, all job titles from the individual profiles could be listed, with duplicates removed. Numerical properties may be summed, averaged, etc. as appropriate for the meaning of the data. For example, each person's affinities may have weight values. The aggregator for affinities may take the weight values for a particular affinity and sum them. The list of sums for all the aggregated affinities would demonstrate the nature and degree of expertise that the group has for those categories of information.

According to one aspect of the invention, in a computer system a method comprises: (A) defining a plurality of object profiles having data attributes; (B) aggregating selected data attributes from the plurality of object profiles; and (C) generating a group profile having data attributes representative of a group of the plurality of object profiles. In one embodiment the method further comprises either determining which of the data attributes in the object profiles are to be aggregated, or determining which of the plurality object profiles are to be aggregated to form the group profile. In another embodiment, method further comprises identifying an affinity associated with an object as part of an object profile.

According to second aspect of the invention, in a computer system operatively connectable to a network and capable of executing a communication process for sending and receiving electronic mail documents, a method comprises: (A) defining a plurality of user profiles having data attributes; (B) aggregating the plurality of user profiles to generate a group profile having common data attributes representative of the group of user profiles; and (C) providing the group profile to a requestor for review.

According to a third aspect of the invention, a computer program product and computer data signal for use with a computer system comprises: (A) program code for defining a plurality of object profiles having data attributes; (B) program code for aggregating selected data attributes from the plurality of object profiles; and (C) program code for generating a group profile having data attributes representative of a group of the plurality of object profiles.

According to a fourth aspect of the invention, an apparatus for use with a computer system comprises: (A) a property collector for receiving attribute data from at least one source and generating a plurality of object profiles therefrom; (B) program logic for identifying at least some of the plurality of object profiles comprising a group definition; and (C) at least one profile aggregator, responsive to the plurality of object profiles generated by the property collector and identified by the group definition, for aggregating the plurality of user profiles to generate a group profile having data attributes representative of the user profiles identified by the group definition.

### BRIEF DESCRIPTION OF THE DRAWINGS

The above and further advantages of the invention may be better understood by referring to the following description in conjunction with the accompanying drawings in which:

FIG. 1 is a block diagram of a computer systems suitable for use with the present invention;

FIG. 2 is a illustrates conceptually the relationship between the components of the system in which the present invention may be utilized;

FIG. 3 is a conceptual illustration of a computer network environment in which the present invention may be utilized;

FIG. 4 is a conceptual illustration of a data structure in accordance with the present invention;

FIGS. 5A-B form a flow chart illustrating the process steps performed by the present invention;

FIGS. 6A-D are conceptual illustrations of a conversation-thread trees in accordance with the present invention;

FIG. 7 is a conceptual illustration of an alternative conversation-thread tree superimposed with a time-line;

FIG. 8 is a conceptual illustration of a micro view of a document as part of a conversation-thread tree in accordance with the present invention;

FIGS. 9-13 are conceptual illustrations of an inbox and various aspects thereof in accordance with the present invention;

FIGS. 14-16 are conceptual illustrations of the inbox and various aspects of the Kgap alert function in accordance with the present invention;

FIG. 17 illustrates conceptually an exemplary software application with which the present invention may be utilized;

FIGS. 18 is a conceptual illustration of the component of an aggregation system in accordance with the present invention; and

FIG. 19 is a flow chart illustrating the process steps performed during the Kgap alert function by the present invention.

### DETAILED DESCRIPTION

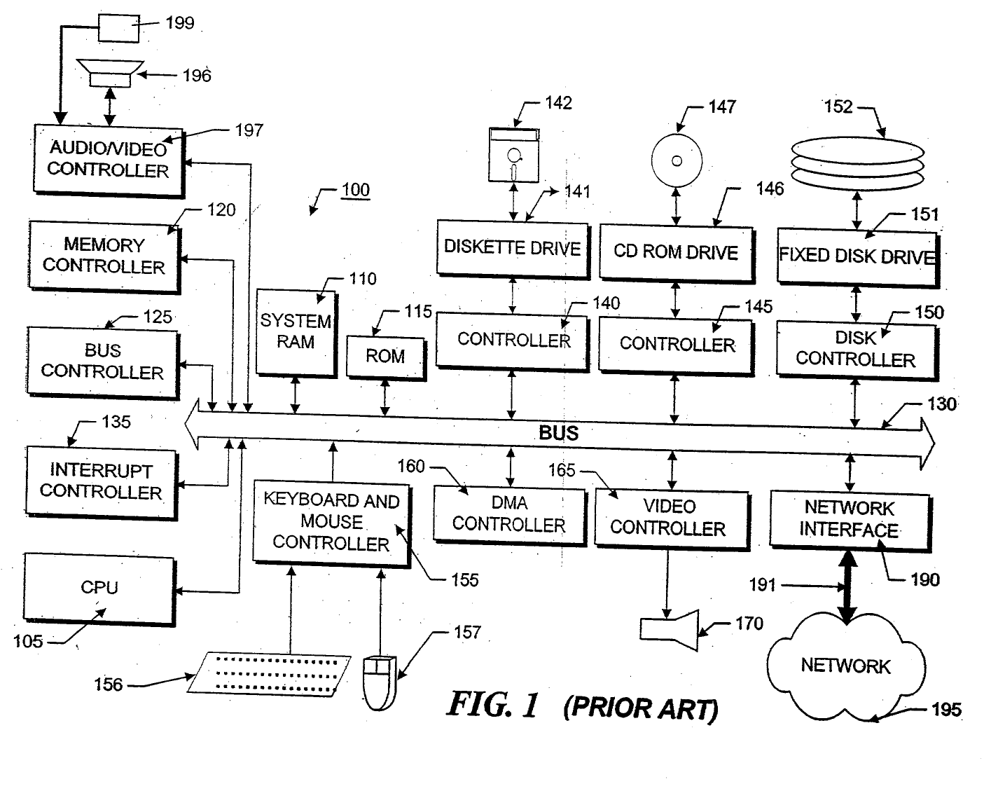

FIG. 1 illustrates the system architecture for a computer system 100, such as a Dell Dimension 8200, commercially available from Dell Computer, Dallas Tex., on which the invention can be implemented. The exemplary computer system of FIG. 1 is for descriptive purposes only. Although the description below may refer to terms commonly used in describing particular computer systems, such as an IBM Think Pad computer, the description and concept equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146, which is connected to bus 130 by controller 145. Hard disk 152 is part of a fixed disk drive 151, which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic, use interface presented thereon by an application or the operating system, in addition to or in combination with any keyboard, pointing device, joystick, voice recognition system, speakers, microphone or any other mechanism through which the user may interact with the computer system. Computer system 100 also includes a communications adapter 190, which allows the system to be interconnected to a local area network (LAN) or a wide area network (WAN), schematically illustrated by bus 191 and network 195.

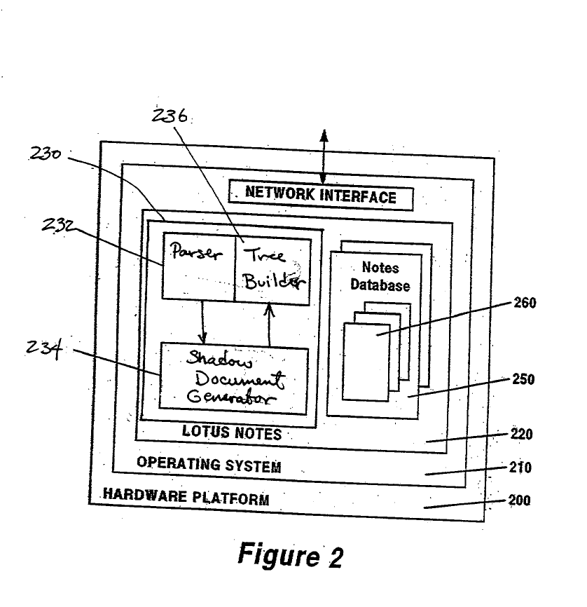

Computer system 100 is generally controlled and coordinated by operating system software, such as the WINDOWS NT, WINDOWS XP or WINDOWS 2000 operating system, commercially available from Microsoft Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including OS/2, AIX, UNIX and LINUX, DOS, etc. The relationship among hardware 200, operating system 210, and user application(s) 220 is shown in FIG. 2. One or more applications 220 such as Lotus Notes or Lotus Sametime, both commercially available from International Business Machines Corporation, Armonk, N.Y., may execute under control of the operating system 210. If operating system 210 is a true multitasking operating system, multiple applications may execute simultaneously.

In the illustrative embodiment, the present invention may be implemented using object-oriented technology and an operating system which supports execution of object-oriented programs. For example, the inventive code module may be implemented using the C++ language or as well as other object-oriented standards, including the COM specification and OLE 2.0 specification for MicroSoft Corporation, Redmond, Wash., or, the Java programming environment from Sun Microsystems, Redwood, Calif.

In the illustrative embodiment, the elements of the system are implemented in the Java programming language using object-oriented programming techniques. Java is a compiled language, that is, programs are written in a human-readable script and this script is then provided to another program called a compiler which generates a machine-readable numeric code that can be loaded into, and directly executed by, a computer. As described below, the Java language has certain characteristics which allow a software developer to easily use programs written by others while still providing a great deal of control over the reuse of programs to prevent their destruction or improper use. The Java language is well-known and many articles and texts are available which describe the language in detail. In addition, Java compilers are commercially available from several vendors including Borland International, Inc. and Microsoft Corporation. Accordingly, for reasons of clarity, the details of the Java language and the operation of the Java compiler will not be discussed further in detail herein.

As will be understood by those skilled in the art, Object-Oriented Programming (OOP) techniques involve the definition, creation, use and destruction of “objects”. These objects are software entities comprising data elements, or attributes, and methods, or functions, which manipulate the data elements. The attributes and related methods are treated by the software as an entity and can be created, used and deleted as if they were a single item. Together, the attributes and methods enable objects to model virtually any real-world entity in terms of its characteristics, which can be represented by the data elements, and its behavior, which can be represented by its data manipulation functions. Objects are defined by creating “classes” which are not objects themselves, but which act as templates that instruct the compiler how to construct the actual object. A class may, for example, specify the number and type of data variables and the steps involved in the methods which manipulate the data. When an object-oriented program is compiled, the class code is compiled into the program, but no objects exist. Therefore, none of the variables or data structures in the compiled program exist or have any memory allotted to them. An object is actually created by the program at runtime by means of a special function called a constructor which uses the corresponding class definition and additional information, such as arguments provided during object creation, to construct the object. Likewise objects are destroyed by a special function called a destructor. Objects may be used by using their data and invoking their functions. When an object is created at runtime memory is allotted and data structures are created.

Network Environment

The illustrative embodiment of the invention may be implemented as part of Lotus Notes® and a Lotus Domino server, both commercially available from Lotus Development Corporation, Cambridge, Mass., a subsidiary of International Business Machines Corporation, Armonk, N.Y., however it will be understood by those reasonably skilled in the arts that the inventive functionality may be integrated into other applications as well as the computer operating system.

The Notes architecture is built on the premise of databases and replication thereof. A Notes database, referred to hereafter as simply a “database”, acts as a container in which data Notes and design Notes may be grouped. Data Notes typically comprises user defined documents and data. Design Notes typically comprise application elements such as code or logic that make applications function. In Notes, every database has a master copy which typically resides on the server or user platform where the database was created. All other copies of the database are replicas of the master copy. Replicas of databases may be located remotely over a wide area network, which may include as a portion thereof one or more local area networks. In the illustrative every object within a Notes database, is identifiable with a unique identifier, referred to hereinafter as “Note ID”, as explained hereinafter in greater detail.

A “document” as used herein may refer to a document, database, electronic mail message code, a “Note” or any file which is accessible and storable by a computer system. The Notes Storage Facility (NSF) architecture defines the manner in which documents and databases are created, modified and replicated among Notes servers across a computer network. Information regarding the Notes Storage Facility and its specification is available from Lotus Development Corporation as well as on-line at www.Notes.net.

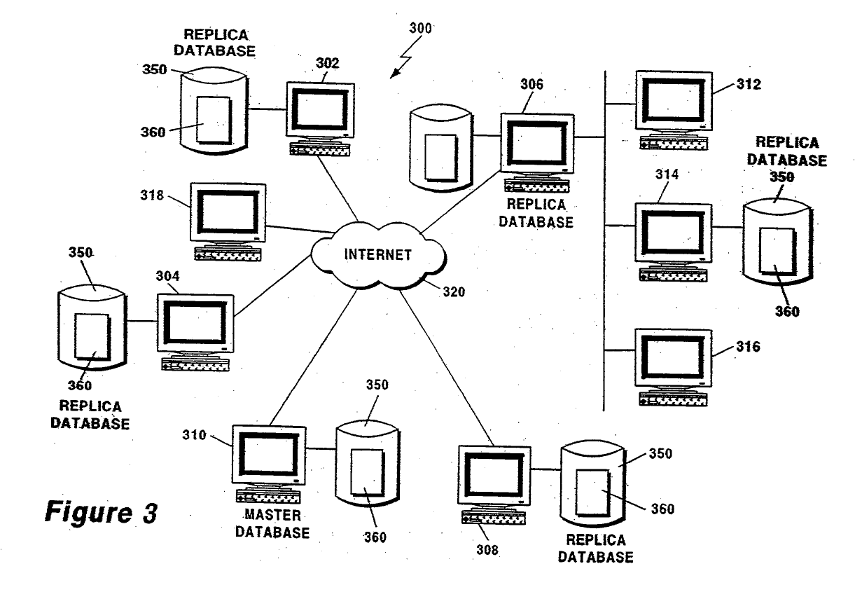

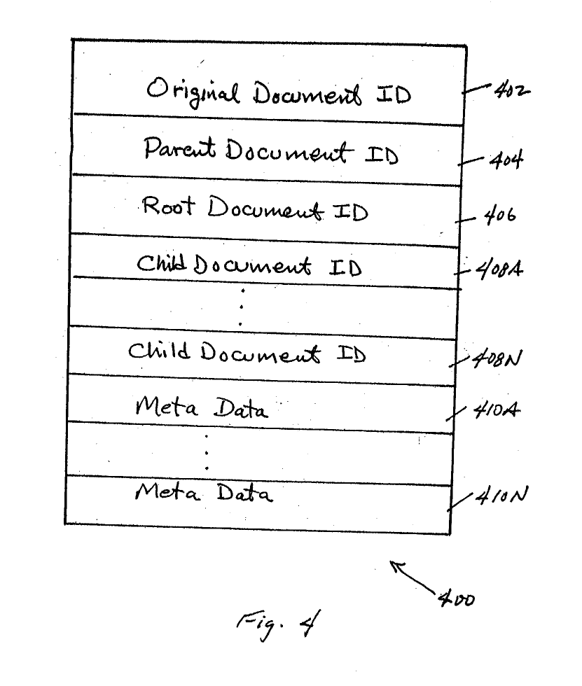

FIG. 3 illustrates a network environment in which the invention may be practiced, such environment being for exemplary purposes only and not to be considered limiting. Specifically, a packet-switched data network 300 comprises a servers 302-310, a plurality of Notes processes 310-316 and a global network topology 320, illustrated conceptually as a cloud. One or more of the elements coupled to global network topology 320 may be connected directly or through Internet service providers, such as America On Line, Microsoft Network, Compuserve, etc. As illustrated, one or more Notes process platforms may be located on a Local Area Network coupled to the Wide Area Network through one of the servers.

Servers 302-308 may be implemented as part of an all software application which executes on a computer architecture similar to that described with reference to FIG. 1. Any of the servers may interface with global network 320 over a dedicated connection, such as a T1, T2, or T3 connection. The Notes client processes 312, 314, 316 and 318, which include mail functionality, may likewise be implemented as part of an all software application that run on a computer system similar to that described with reference to FIG. 1, or other architecture whether implemented as a personal computer or other data processing system. As illustrated conceptually in FIG. 3, servers 302-310 and Notes client process 314 may include in memory a copy of database 350 which contains document 360. For purposes of illustration, the copy of database 350 associated with server 310 is designated as the “master” copy of database 350. All other copies of database 350 within the network are replica copies of the master copy.

Shadow Document Generation

To implement the functionality of the present invention in a Lotus Notes environment, a module, referred to hereafter as Notes Mail Agent 230 interacts with the existing functionality, routines or commands of Lotus Notes client application and/or a Lotus “Domino” server, many of which are publicly available. The Lotus Notes client application, referred to hereafter as application 220, executes under the control of operating system 210 which in turn executes within the hardware parameters of hardware platform 200. Hardware platform 200 may be similar to that described with reference to FIG. 1. Mail Agent 230 interacts with application 220 and with one or more document 250 in databases 260. The functionality of Mail Agent 230 and its interaction with application 220 and databases 260 is described hereafter. In the illustrative embodiment, module 230 may be implemented in an object-oriented programming language such as C++. Accordingly, the data structures and functionality may be implemented with objects displayable by application 220 may be objects or groups of objects. In light of the description herein, the construction and function of module 230 is within the scope of understanding of those reasonably skilled in the arts.

Mail Agent 230 comprises a parser 232, a shadow document generator 234 and a conversation thread tree builder 236. The primary function of Notes Mail Agent 230 is to create a shadow document from an original document, which, in the illustrative embodiment, is an electronic mail message. Typically, this process is triggered by an occurrence of an event. In the first illustrative embodiment, Mail Agent module 230 may be invoked upon the sending of an electronic mail message by a Lotus Notes client application. In this instance, Agent 230 may reside within the Lotus Notes client, as illustrated in FIG. 2 or on the same system. Simultaneously, a Lotus Notes Mail Agent 230 may execute on a Lotus Notes “Domino” server and function to create a shadow document for each document or electronic message transmitted from other non-Notes processes prior to delivery to a recipient Notes process. The shadow documents are generated transparent to the actual user sending or receiving the electronic message. Alternatively, in a second illustrative embodiment, described herein Mail Agent 230 may be invoked upon the receipt of a request to delete an original document or electronic mail message.

Mail Agent 230 creates a shadow document from an original document by generating a file containing data related to the document. In the illustrative embodiment, shadow documents are stored as documents in a Lotus Notes database and are accessible via the Notes Storage Facility (NSF) Application Program Interfaces. Specifically, shadow documents are stored in a Notes mail database. The data maintained in a shadow document defines the parent/child relationships among original documents and their respective shadow documents. In the illustrative embodiment, a new electronic mail message is considered a parent document and serves as the root from which a new shadow tree may be derived, as explained hereinafter. Any replies to the original electronic mail message is/are considered a child/children document(s). Within a conversation thread, and a hierarchical tree that represents such thread, children documents derive from a common root document. Accordingly, a parent/child tree hierarchy representing a conversation thread terminates at one extreme with a root document, or a shadow document thereof, and, at the other extreme, with one or more children documents, or shadows thereof, as the leaves of the tree.

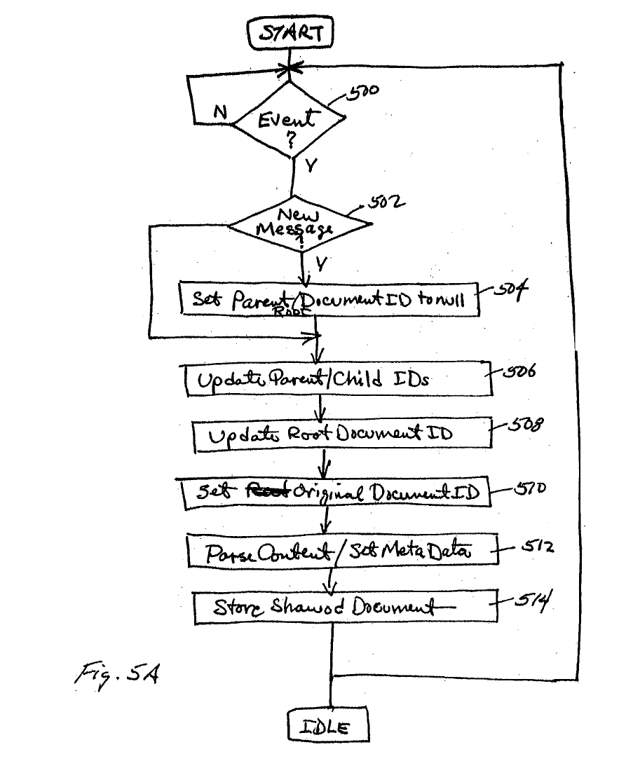

FIG. 4 illustrates conceptually the structure and content of a shadow document 400 in accordance with the present invention. As shown, shadow document 400 comprises an Original Document Identified (ID) 402, a Parent Document ID 404, an optional Root Document ID 406, one or more Child Document IDs 408a-n, and optional Meta Data fields 410a-n. Original Document ID 402 may comprise a pointer to the original document, e.g. an electronic mail message, which may no longer exist in the database. Parent Document ID 404 may comprise a pointer to the immediate parent document, whether a shadow or original document, in the tree hierarchy. Parent Document ID 404 may have a null value if the subject document is the root of the conversation thread tree. Optional Root Document ID 406 may comprise a pointer to the root of the conversation thread tree, whether shadow or original. Root Document ID 406 allows for efficiency in traversing the tree hierarchy. Child Document IDs 408a-n may comprise a list of pointers to the immediate children documents, whether shadow or original, in the tree hierarchy, if any. In the illustrative embodiment the value of Ids 402-408 may be the Notes ID value for a document. Additionally, Meta Data fields 410a-n may comprise meta data describing the original electronic message documents and/or any attachments thereto.

In the illustrative embodiment, the meta data may include such logistical information as sender, receiver, original size, subject, date, any carbon copy recipients, etc. associated with the document. In addition, key words or summaries of the content of the document or any attachments may likewise be included. Such functionality may be performed by Mail Agent 230 with calls to commercially available products such as Intelligent Miner for Text from IBM Corporation, Armonk, N.Y., or KeyView from Verity, Sunnyvale, Calif., which then parse and filter the content to find key words or create summaries. The technique and algorithms for generating summaries of the content of the document or any attachments are described in greater detail hereinafter.

At the time a document, particularly an electronic message is generated, shadow document generator 234 includes code routines or objects, which, upon invocation sets up a shadow document and identifies any parent and/or child documents of the subject document optionally, further identifies the root document of a conversation-thread tree to which the subject document is a member. A similar process is performed by the shadow document generator 234 of a Mail Agent 230 executing on a Domino server. Parser 232 includes code routines or objects, which, upon invocation sets up a shadow document and parses the original document and any header of the following data fields: sender, receiver, original size, subject, date, any carbon copy receivers, attachment names, etc. and makes call to filtering software modules, as necessary. A shadow file is stored in an email database which may then be replicated in the manner previously described in the Notes environment.

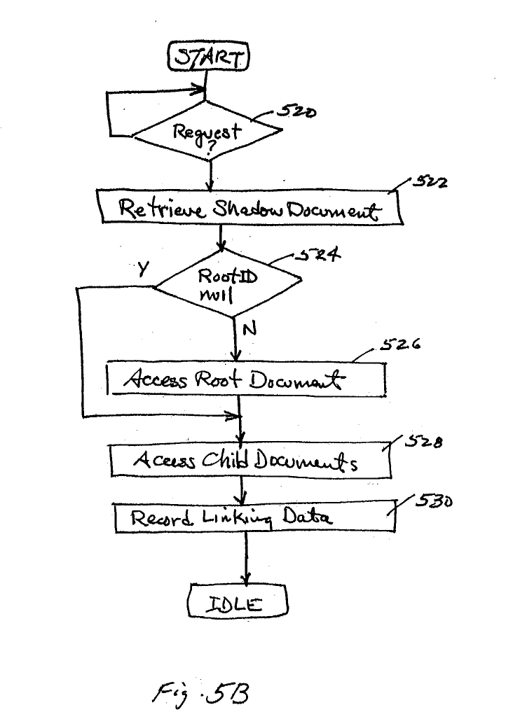

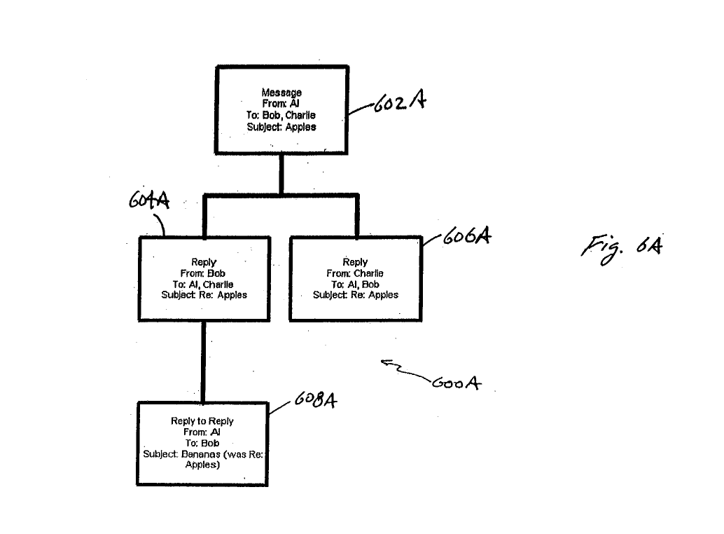

FIGS. 5A and B are flow charts illustrating the process steps performed by parser 232 and shadow document generator 234 during the present invention. As illustrated in FIG. 5A, Mail Agent 230 first detects the occurrence of a triggering event as illustrated by decisional step 500. Such event may include the sending or receipt of an electronic message, or, alternatively a request to delete an electronic message. Next, Mail Agent 230 determines if the electronic message is a new message, as illustrated by decisional step 502. If so, Root Document ID 406 and Parent Document ID 404 are both set to null, as illustrated by procedural step 504. Otherwise, Mail Agent 230 sets the Parent Document ID 404 to a pointer value referencing the parent document and simultaneously modifies one of the Child Document IDs 408a-n of the parent document to reference the subject shadow document, as illustrated by procedural step 506. Additionally, Mail Agent 230 sets Root Document ID 406 to reference the root of the conversation thread tree, as illustrated by procedural step 508. Mail Agent 230 then sets the Original Document ID 402 to reference the original document from which the shadow document was created, as illustrated by procedural step 510. If the original document has been deleted, the value of Original Document ID 402 is set to null. Finally, Parser 232 parses the header information of the original electronic message for meta data and populates Meta Data fields 410a-n accordingly, as illustrated by procedural step 512. Parser 232 may optionally make procedure calls for scanning of the document content or any of its attachment for key words or phrases to be saved as meta data. Thereafter, the shadow document is stored in memory, which, in the illustrative embodiment, is a mail database, as illustrated by procedural step 514.

The above-described process is substantially the same whether the Mail Agent 230 resides in the Notes client or a Domino server in a Notes environment. In addition, if the triggering event in step 500 was a request for deletion of an original document, instead of pointing only to other shadow documents, the pointer values of the IDs 404-408 within shadow document 400 may also reference other original documents as well.

Given the content of shadow documents and their relationship to the original or root document, an algorithm in Tree Builder 236 can be used to traverse the chain of pointers or references to the parent of each shadow document, and, once the root has been identified, to then recursively traverse all references to each child document. In this manner, a complete parallel tree representing the conversation thread may be determined from the data collected by Tree Builder 236. The data identifying the documents or nodes of the tree, can then provided to program code which may visually render the tree for the users benefit, as discussed in greater detail herein.

Referring to FIG. 5B, the process steps performed by conversation thread Tree Builder 236 is illustrated. Initially, Tree Builder 236 receives a request to construct a conversation thread tree, as illustrated by decisional step 520. Such request may be triggered by any number of different events including selection of a specific command within the Notes client application 220, automatically upon entering the mail function of the Notes client, or upon selection of an electronic message from a mail viewer utility. Tree Builder 236 receives the identifier of a document, typically a Notes ID, and retrieves the corresponding shadow document data from the mail database, as illustrated by procedural step 522. Next, Tree Builder 236 examines the Root Document ID field of the accessed shadow document and determines if the field contains a null value, as illustrated by decisional step 524. If the value of the Root Document ID field is not null, Tree Builder 236 retrieves the document identified by the pointer within the Root Document ID field, whether a shadow or original document, as illustrated by procedural step 526. Next, generator 236 resolves the child document IDs 408a-n in the Root Document, as well as each of their respective child documents, in a recursive manner, as will be understood by those reasonably skilled in the arts, until the Child Document IDs in all child documents are null, indicating that the leaf nodes within the conversation thread tree have been identified, as illustrated by steps 528. Tree Builder 236 progressively records the document IDs in a file during the resolution process and, upon completion, stores such data a file or document in memory, as illustrated by steps 530.

In an alternative implementation, since a large number of electronic mail messages are received, a large number of shadow documents will be generated. To reduce memory requirements, while still providing the functionality of the invention, the data from all shadow documents within a conversation thread may be stored in a single tree document within a Lotus Notes database, instead of multiply documents. In this embodiment, a single shadow document will include all of the meta data of the individual Notes within the tree, such document may be kept in the database using XML format or other markup language utilizing tags.

Visualization

With complete message thread information using the techniques described herein, visualization of a conversation thread trees is possible. Since conversation thread trees, from observations, are not very deep nor very bushy in general, a simple graphical representation of the message thread and highlighting of the interesting relationships among the parties involved in the conversation is possible. The tree data compiled by generator 236 may then be provided to a graphics program for visually rendering a conceptual representation of a conversation thread tree. For example, the existing DiscussionsThreadsView functionality within Notes can be used to construct and display a complete conversation thread.

In the illustrative embodiment, we are using Lotus Domino for the underlying object store. The user interface may be developed using IBM Sash, a development environment based upon dynamic HTML and JavaScript. A JAVA applet running in a portion of the Notes client gets the Notes document data representing the tree Notes from the data base and renders the tree graphically. Notes may be rendered with different graphic elements such as color to define relationships. By selecting of one of the nodes in a tree by user can, in one embodiment, cause a low resolution display of that document, either the original or the shadow document, to be displayed within the context of the tree.

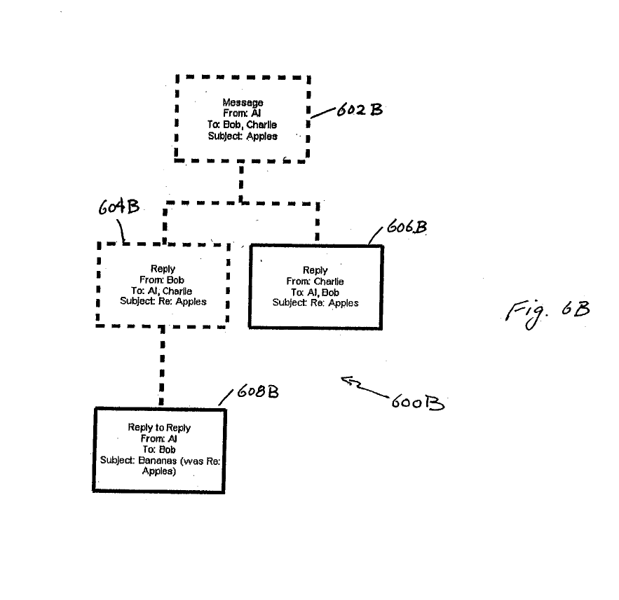

FIG. 6A-D illustrate a conversation thread in the form of a document trees 600A-D. In FIG. 6A, tree 600A represents an original conversation thread in which an electronic message from Al to Bob and Charlie serves as the root document 602A of the tree 600A. Documents 604A, 606A, and 608A are replies or replies to replies and therefore child documents of parent/root document 602A. For the sake of illustration, assume that documents 602A and 604A are deleted by one or more of the respective recipients, resulting in the conversation thread tree 600B as illustrated in FIG. 6B. In FIG. 6B, documents 602B and 604B are shown in phantom, indicating that the original document has been deleted. With the present invention, a shadow tree 600C was created comprising documents 602C-608C, which are the shadow documents of documents 602A-608A, respectively. The relationship of shadow tree 600C and the original conversation thread tree 600A is illustrated in FIG. 6C. The shadow tree 600C remains in tact and may be constructed and viewed as necessary despite original documents 602A and 604A having been deleted. In an embodiment in which shadow documents are created upon a request to delete the original document, such as that illustrated in FIG. 6D, the conversation thread tree 600D is a hybrid tree consisting of shadow documents 602C-604C and original documents 606D and 608D.

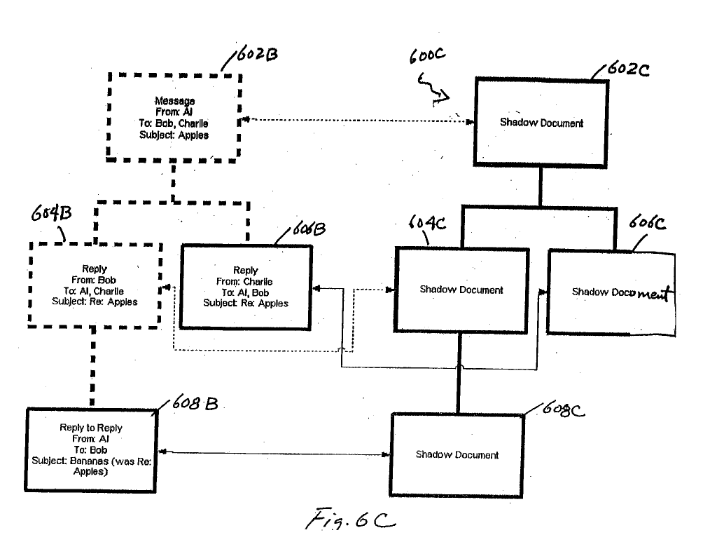

One attribute of electronic mail that is valuable to visualize is the time when a message was received. The present invention combines the message trees described above with a timeline to produce a more useful visualization. FIG. 7 illustrates a design for displaying a message tree on a timeline. In FIG. 7, the vertical lines represent day boundaries. The text in the middle band is the subject of the thread. The nodes may be color-coded to indicate the relationship of the message senders to the recipient. Note that time is non-linear in this display; days with little or no activity are shown compressed to avoid the problem of large gaps in the time display. For example, a timeline can be broken to show a large passage of time. This might be useful if email is received from someone infrequently. In that case, the system could show on the timeline the most recent threads of conversation with that person. Also, information from people's calendars may be incorporated to aid in the search. For example, a user might remember that he/she received a certain piece of mail just before going for vacation last summer. By incorporating these “milestones” on the timeline view the information can be found more easily. The present invention places message nodes proportionally within a day even though the width of a day on the timeline may vary.

The design of a new email client in accordance with the invention is shown in FIG. 4. The client combines a traditional list of email messages with a time-based message tree. The node for the selected message may be replaced with a reduced-resolution overview. A dimmer, secondary highlight also connects the messages within the thread.

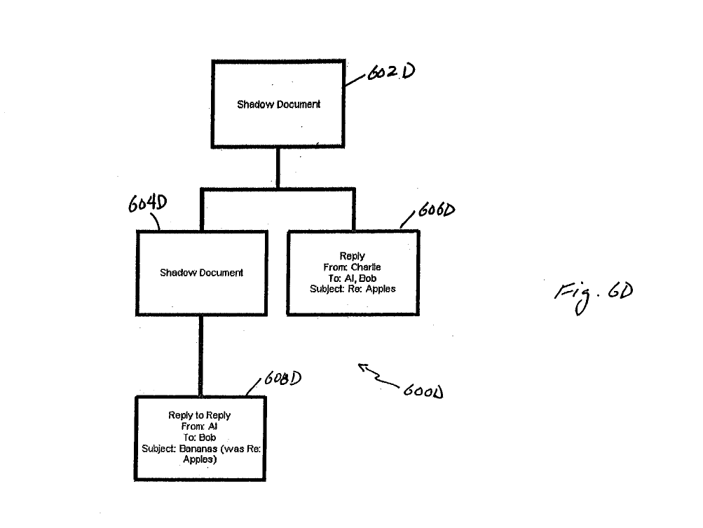

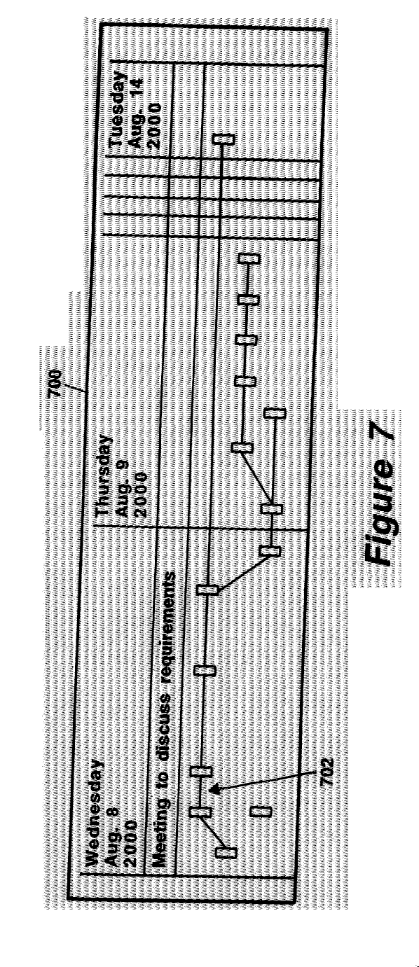

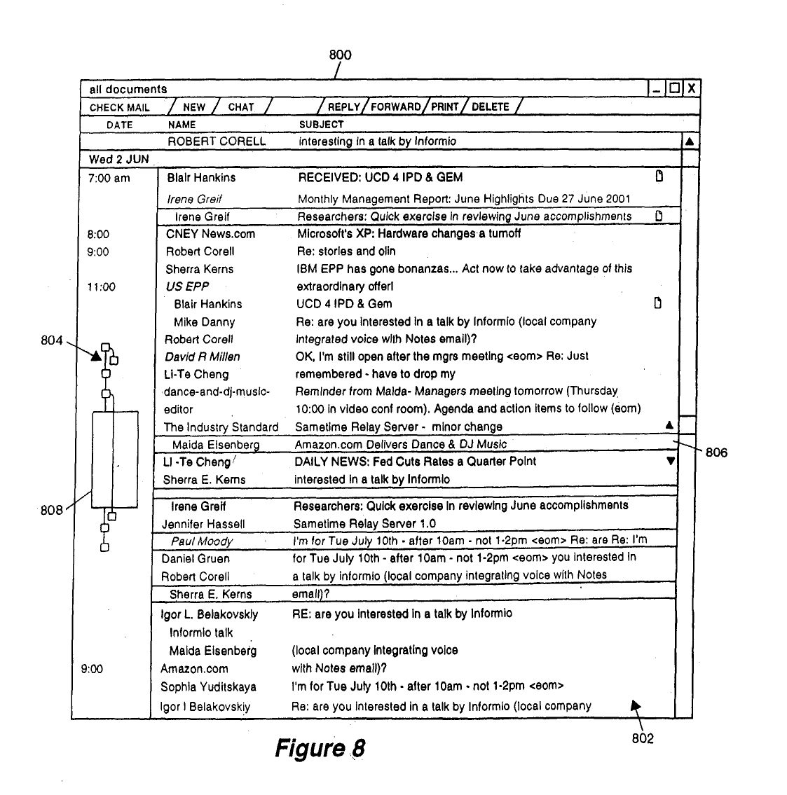

FIG. 8 shows a design for the display of search results. In this case, the search might have been “show the last seven days of email from Dan.” Dates are listed across the top and overviews of the message bodies are shown in the column below. Dates without any messages are omitted. This interface allows a user to scan the email in the same way that a pile of physical mail would be scanned. It is easy to separate the short messages from the longer messages. Similarly, it is easy to pick out the messages that contain images. The messages highlighted in a single color designate the same thread. Finally, with some simple coloring of the text based upon extracted features (red to highlight names and dates in this example), message stands out from the others. It is, in fact, a travel itinerary. Although other systems have used reduced-resolution document overviews in their user interface (see, for example), email, in particular, would benefit from such visualization. Email has structure that other client software has failed to exploit. With an overview, people can quickly pick out different types of email (e.g., agendas, online purchase receipts, corporate-wide announcements). Automatic classification of this sort has proven error-prone.

Improved Electronic Mail Inbox

The present invention contemplates a new concept electronic mail Inbox 900. As illustrated in FIG. 9, when a message 902 is selected, here, a message from Chet Stevens regarding results of durability testing, is accessed and a preview of the message 904 is displayed. When a message is selected that is part of a thread, the other items 906-910 in the thread are highlighted in the display, as illustrated in FIG. 9 in which three other electronic mail entries are highlighted. In addition, a map 912 illustrating other messages in the conversation thread—the Ccs, the Reply Tos, the forwards, is displayed. Whereas such items were not easily displayable in electronic mail inboxes that have a linear, date centric flow of email, the Inbox of the present invention brings all the items related to an activity together in one place and facilitates navigate therethrough.

The preview 902 can be generated using the electronic mail summarization techniques described herein. In addition, the maintenance and tracking of a thread specifically in the form of a file or object can be performed using the shadow document and tree generation techniques described herein. In the Inbox 900 of the present invention, it is contemplated that multiple previews of electronic mail may be displayed simultaneously in either separate or overlapping regions of the user interface of inbox 900.

Multiple Source Inbox

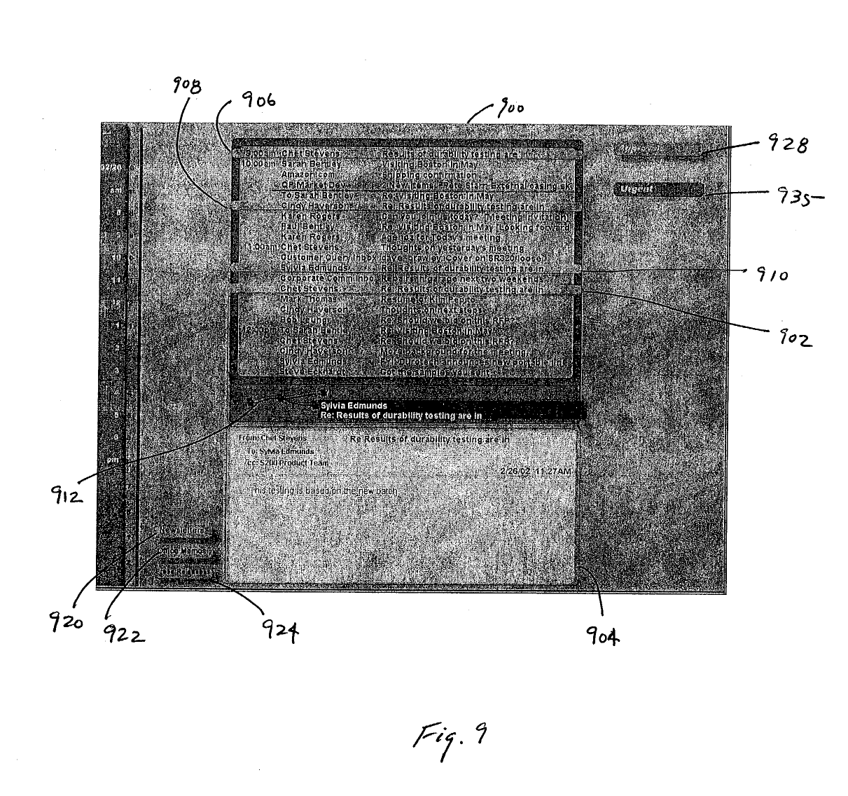

According to another aspect of the present invention, inbox 900 is capable of receiving not only electronic messages but data and documents from other sources such as databases, templates and other information sources. Studies have shown that people tend to spend significant amounts of time in their inbox. People don't like having to keep checking other databases or outside mail boxes. Mailbox 900 in accordance with the present invention, tracks messages in other sources without actually including such information in the inbox 900. Using the shadow document generation techniques described herein, a surrogate document including meta data such as size, date, heading information and a pointer to the pointer actual data, is generated by Notes Mail Agent 230 and placed in inbox 900. For example, FIG. 10 illustrates an item 914 stored in a corporate communication database. In addition, FIG. 10 illustrates an item 916 that had been sent to a Customer Query inbox and flagged there for the users attention.

Notes mail agent 230 may be provided with the names of selected individuals and the addresses of the databases or other inboxes necessary to monitor such external information. Mail agent 230 upon receiving data associated with a particular user generates a shadow or circuit document, in a manner as described herein and transmits the surrogate document to inbox 902. In this manner, inbox 900 becomes the central location for receiving not only electronic mail but other sources of information useful to a user. Selection of the surrogate document 916 from inbox 900 causes the pointer data to be resolved and the actual data retrieved and displayed as item 918 within the inbox 900, as illustrated in FIG. 10.

Calendar Bar

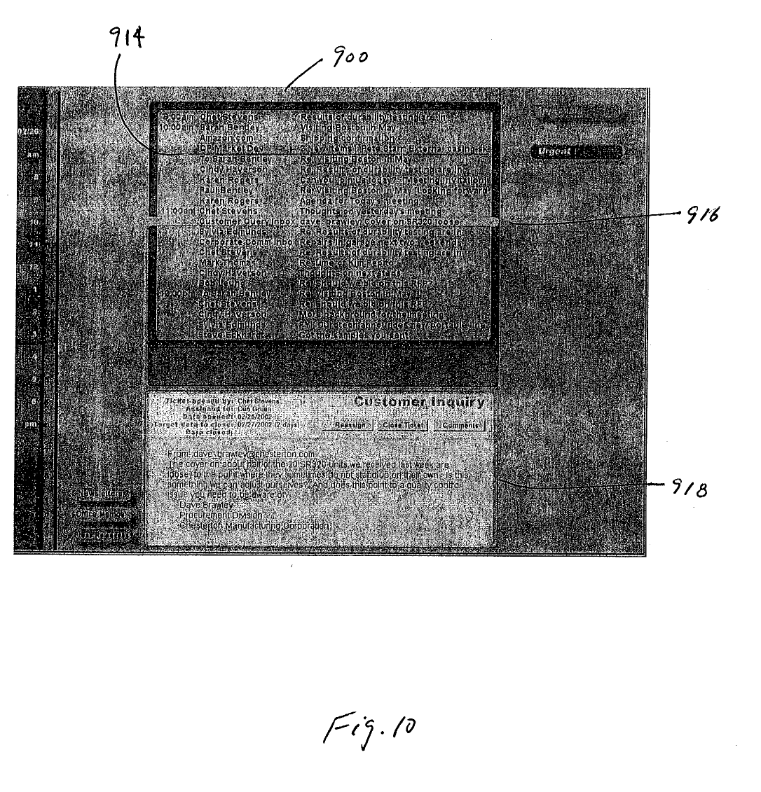

According to another aspect of the present invention, a calendar bar 940 is displayed simultaneously with the main electronic mail list in inbox 900, as illustrated in FIG. 11. The calendar bar 940, in the illustrative embodiment, is arranged vertically and displays a chronological legend for multiple days and, upon selection of a date, or the current date, increments of time. As shown in FIG. 11, the calendar bar may show the day divided into hours, however, it will be obvious to those reasonably skilled in the arts that other increments of time, whether smaller or larger, may be displayed.

Calendar bar 940 may represent the personal calendar of the user, or, alternatively, a team calendar for multiple individuals. Selection of a specific time, typically by hovering the cursor of a pointing device over the region designated to a specific time slot causes data associated with the meeting to be displayed next to the designated time slot, as illustrated by region 942 or, alternatively, in a separate window. The data associated with the meeting may vary in detail and scope depending on the designer preferences, but will typically include the start and end times, the location, topic, type, i.e. call-in, video conference, etc., the participants, relevant telephone numbers, network addresses, and/or references to relevant data and materials. Any of the above items may be displayed in window 942, as desired.

In the illustrative embodiment, each time-slot associated with the calendar may have a folder or object associated therewith in which such data may be stored and manipulated, e.g., forwarded to another user via electronic mail. With the inventive inbox 900 of the present invention, calendar 940 may be seemlessly integrated with various other entities within the inbox 900.

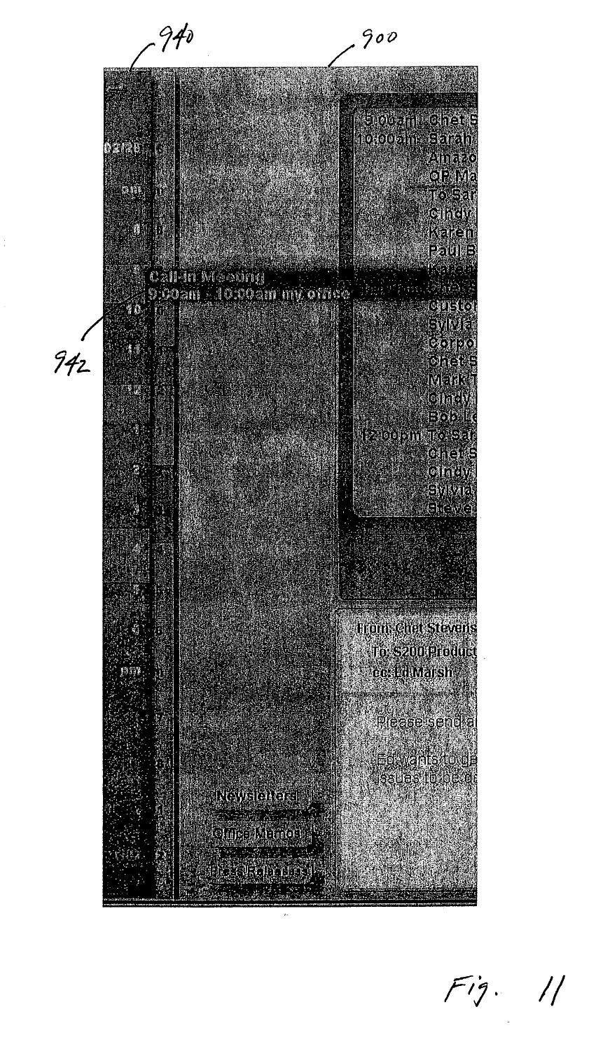

Calendar bar 940 may, according to another illustrative embodiment, be linked to other applications such as Quickplace, commercially available from IBM Corporation, Armonk, N.Y. The Quickplace product provides a web-based user interface to Domino, also commercialy available from IBM Corporation. The Domino product provides a web-based user interface to Lotus Notes, also commercially available from IBM Corporation. Quickplace enables multiple users to interact collaboratively in virtual spaces or meeting rooms and allows multiple users or teams to have calendars associated with a specific team or room. As illustrated in FIG. 12, calendar bar 940 may be configured to show calendar entries from Quickplace, specifically a Quickplace to which the user is a member, as well as the calendars of other Quickplace teams, using appropriate links. In FIG. 12, a window 944 may be displayed and contain information similar to that of window 942 of FIG. 11.

Meeting Invite

In accordance with another aspect of the present invention, inbox 900 of the present invention may be utilized to facilitate meeting invitations. From inbox 900, a user may view an electronic mail regarding a meeting, including the relevant background information. In the illustrative embodiment, as described herein, selection of the electronic mail causes the relevant thread map to be displayed as well as the original meeting announcement. Selecting the meeting announcement, which may be displayed in a separate window in inbox 900, similar to that shown in item 904 in FIG. 9 causes calendar 940 to be displayed, if not already open. Inbox 900, in accordance with the present invention allows the user to accept the meeting invitation through some affirmative action such as selecting an “Accept” button, which may confirm attendance to the other participants with reply electronic mail. In addition, since the thread map containing the original meeting invitation and the subsequent conversation thread is represented, in the present invention has a first-class object, the complete thread in its entirety may be manipulated. Specifically, if the user desires to invite an additional participant to the meeting, the meeting thread may be selected from inbox 900 and dragged using a mouse or other pointing device to another potential participant contact reference, such as a name in an address book, an address in another electronic mail, or a party with which a communication such as a video conference or a text chat is currently in progress. The meeting thread will then be transmitted to the recipient's inbox accordingly. In this manner, the potential participant now has the entire meeting thread, not just the original meeting invitation.

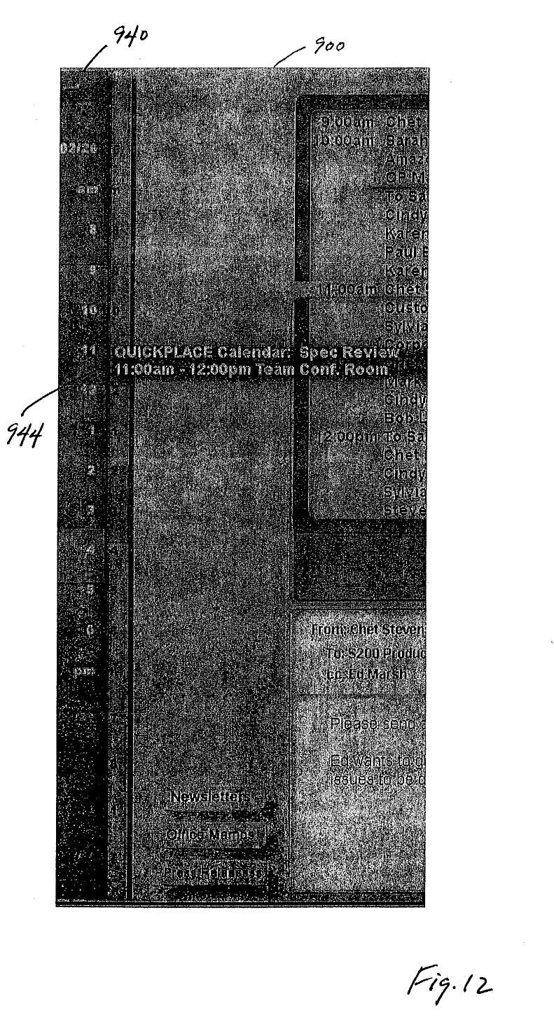

This technique is illustrated by the screen capture of FIG. 13 in which a text chat window 950 is shown displayed with the original meeting invitation 952 and the meeting thread 954 within inbox 900. In the illustrative embodiment, text chat with other electronic mail users may be done with the Sametime or Sametime Connect products commercially available from IBM Corporation. The Sametime product enables a user to determine what other parties are currently online and to perform text chat as well as real time audio/video conferencing with other parties. The Sametime Connect product enables a user to perform instant messaging between users currently on line. The text chat from a Sametime communication may be transcribed and stored as a document. This document may then be sent as an electronic mail to other nonparticipants and may likewise be attached as an annotation to a particular document node of a conversation thread tree.

Kgap and Aggregation of Affinities

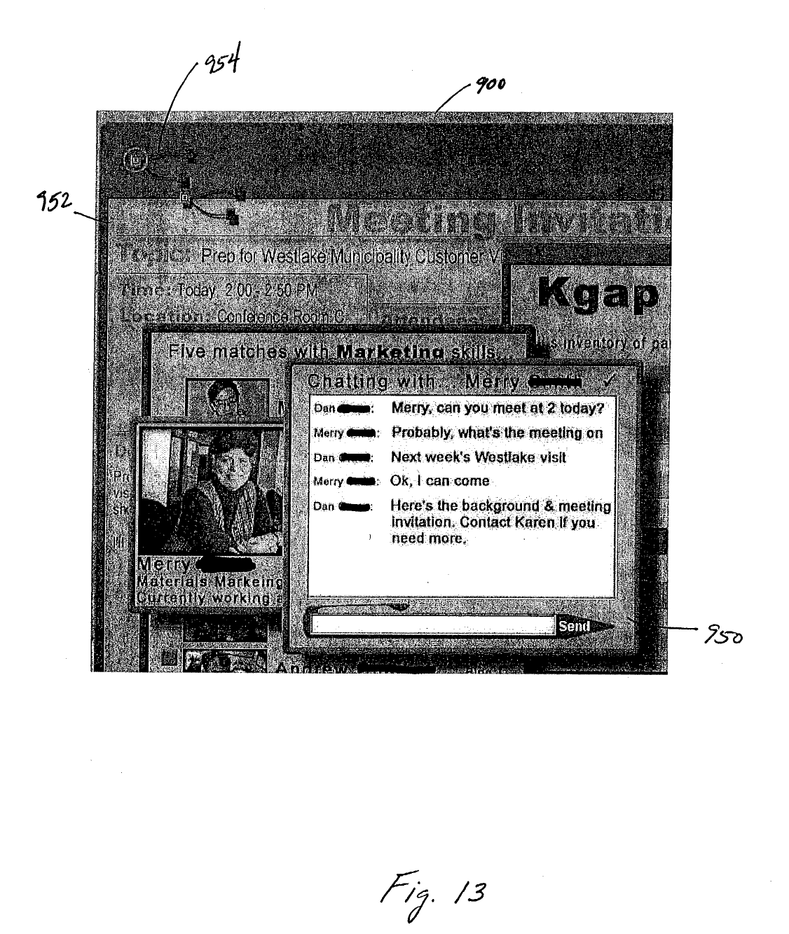

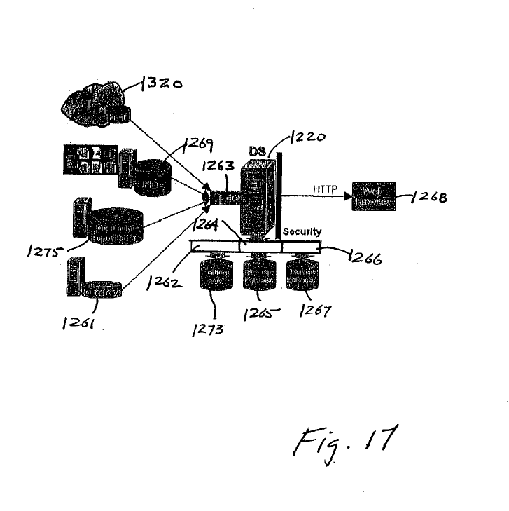

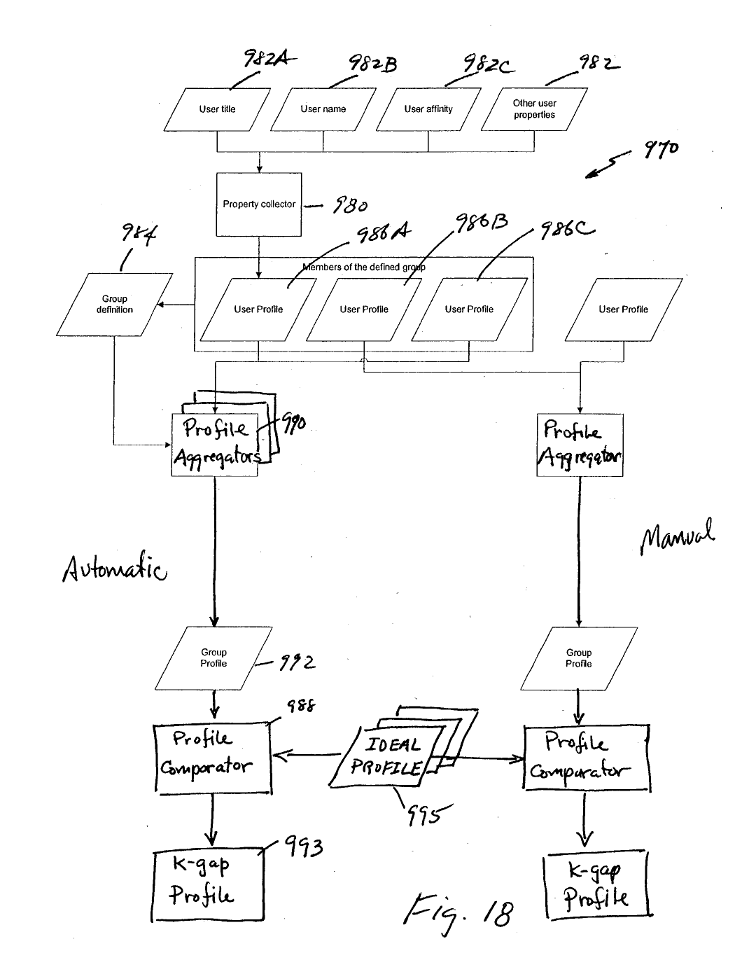

Using the affinity aggregation technique and system described hereafter with reference to FIGS. 17-18, the recipient of the meeting invitation in FIG. 13 may review an analyze of the attributions of the other participants as a whole. Specifically, by selecting a menu option on the user interface of inbox 900, an aggregation system 970 may review the participants listed in the meeting invitation and determine whether a “knowledge gap” or “Kgap” exists among the participants to the meeting. This process occurs using the systems and techniques described with reference to FIGS. 17-18. In the illustrative embodiment, the aggregation system 970 may generate a “Kgap Alert” window 960, as illustrated FIG. 14, if there appears to be a weakness in the collective affinities of the group object. Window 960 comprises a plurality skill bar graphs that indicate the relative strengths of the skills or affinities among the participants to the meeting. As illustrated, the user may ignore the alert by selecting button 962 or may select the Suggest Participant button 964, both as illustrated FIG. 14.

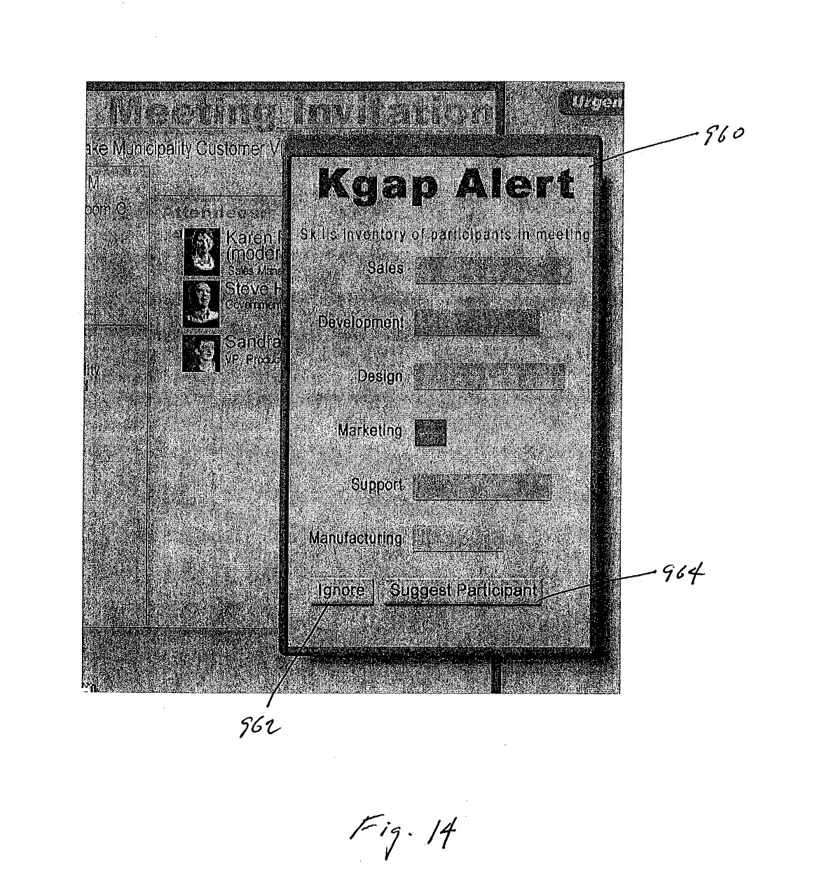

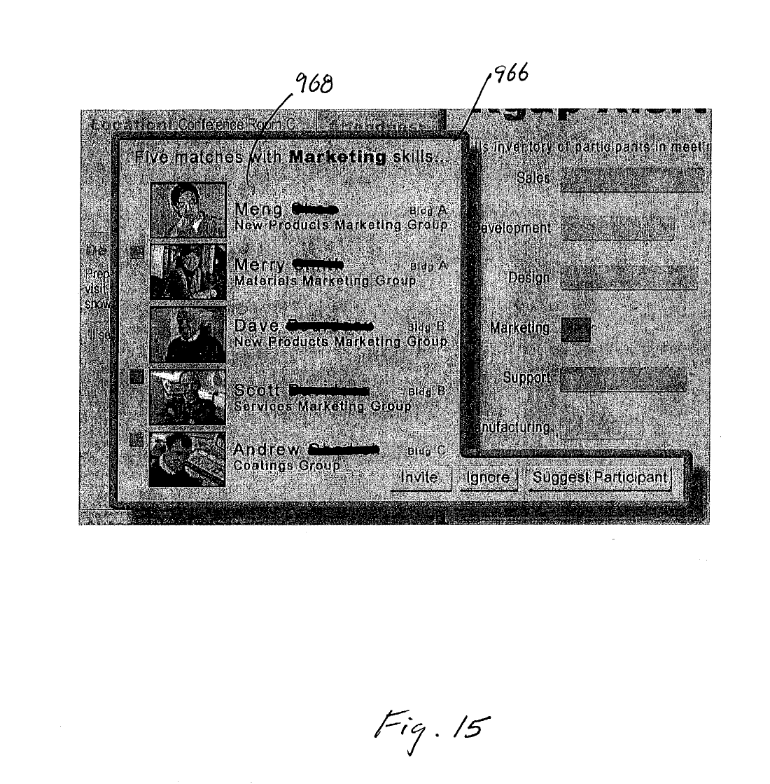

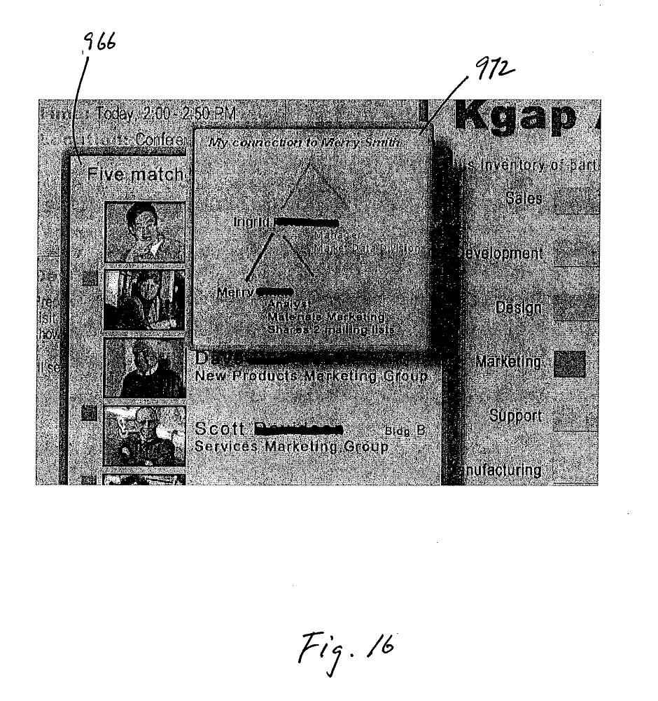

If the Suggest Participant button 964 is selected, the inventive system will generate a list of potential participants with the required skills or experience, as illustrated by window 966 of FIG. 15. Each potential participant identified by the aggregation system 970 may be identified by name, location, title/group, and optionally a photo and a graphic element indicating any social or work connection to the user, as illustrated in FIG. 15. The user may know the first potential participant well, as indicated by the icon 968, here a large yellow circle. However, the first potential participant is not online in the exemplary scenario. The second potential participant is online, and although the user may not recall the person's name, icon 970, a medium yellow dot, indicates there is a social connection between the user and the second potential participant, Merry in the exemplary scenario. Selecting icon 970 causes a window 972 of FIG. 16 to be generated, which illustrates the potential relationship between the user and potential second participant. As illustrated in FIG. 16, the second potential participant and the user are on two shared mailing lists and the second potential participant works for a manager whom the user knows well, in the exemplary scenario.

Utilizing the other functionality of inbox 900 described herein, in conjunction with the Sametime product or other collaborative communication application, the user is able to initiate a chat session with the second prospective participant. Thereafter, the user may send the meeting invitation conversation thread to the second prospective participant. If the second prospective participant agrees to participate in the meeting, they will then be listed as a meeting participant and the user may also accept the meeting, if they have net yet done so. Although the exemplary implementation of the invention has been described with reference to meeting requests and the improved electronic mail inbox disclosed herein, the invention is not limited to any particular implementation or environment. The architecture of the invention as described hereafter may be utilized in any scenario in which it is desirable to aggregate the attributes of individual objects into a group profile.

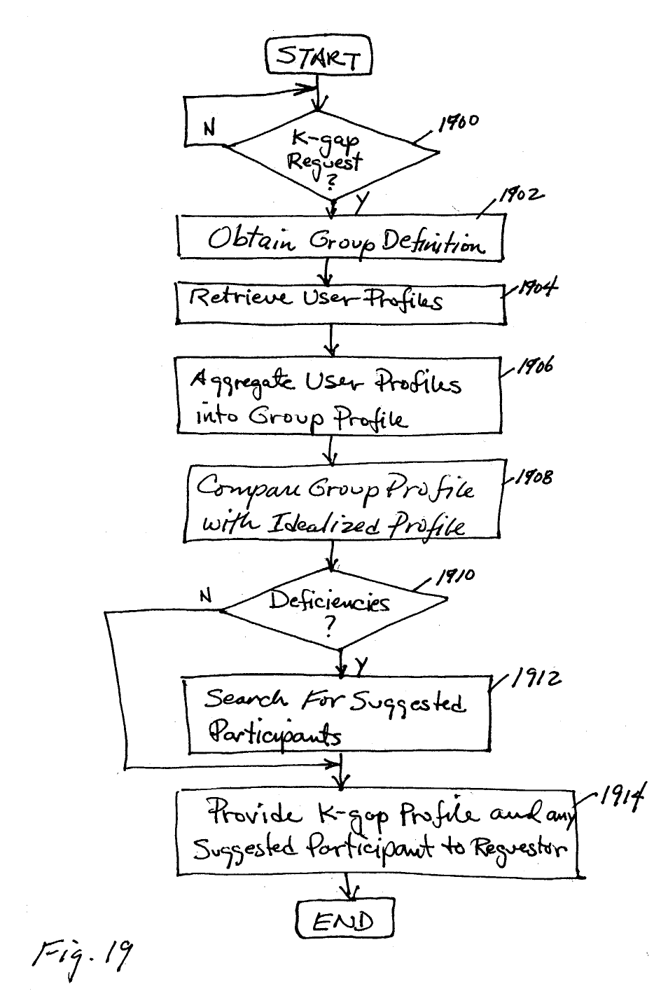

The system for aggregation 970 of information about the properties of individual objects into a group object is disclosed in FIG. 18. System 970 comprises a property collector 980, a plurality of profile aggregators 990A-B and a comparison module 988. Information is collected by a property collector 980 from sources 982A-D and is used to generate user profiles 986A-C, as illustrated. A group definition 984 and the user profiles 986 of the members within the defined group are then provided to a plurality of profile aggregators 990A-N which then use a plurality of techniques to generate a group profile 992. The group profile 992 is compared to an idealized group profile by comparison module 988 to determine if the group profile is deficient in any manner. The results of the comparison, including any deficiencies, are then presentable. This process is described below in greater detail with reference to the flowcharts of FIG. 19.

In the illustrative embodiment and Lotus Notes environment, there are Group objects that control electronic mail mailing lists, database access, and so forth which serve as one or more sources 982A-D. The above-described functionality of Discovery Server 1220 can be utilized to synthesize affinities for areas of expertise for users. Such affinity data may be stored in a separate memory or database 982C, as illustrated in FIG. 18. The other sources of information 982A-B and 982C may be supplied to the discovery server 1220 using data mapping techniques. Specifically, information such as name, address, employee identification information, phone numbers, etc. may be mapped from multiple difference sources, typically databases, to a defined user profile within discovery server 1220, which then adds any affinity profile to the user profiles. Such user profiles 986A-C may be stored in a database accessible by discovery server 1220.

Aggregations may be selected automatically by the system, or manually by system users, but in either case, the system uses its knowledge about the types of data to be aggregated to produce the described result. In the illustrative embodiment, the inventive system contains user profiles, which contain information, or properties, about individual people. Examples may include name, title, e-mail address, telephone numbers, etc. User profiles 986A-C may be stored in a Lotus server application, designated hereafter as a Discovery Server 1220, and may further include information about people's affinities, which indicate a connection between the person and some category of information, such as marketing, sales, manufacturing, etc. Affinities 982C can be created in various ways including calculated automatically using a weighing algorithm, such as described hereafter with reference to the Discovery Server, or declared by the individual, or designated by third party(s).

The Discovery Server 1220 may be used to implement the functionality of property collector 980. In the illustrative embodiment, Discovery Server 1220 may operatively coupled over a network to a system executing an electronic mail application, such as Lotus Notes. Alternatively, Discovery Server 1220 and mail agent 230 may be integrated into the same application, or execute separately on the same platform. Using the Discovery Server 1220, the profiles may be created automatically from one or more sources 982A-D of information about people. The user title may be from one data source, the user address from another, and so on. In such an embodiment that aggregates information automatically—i.e. the system chooses which objects to aggregate—there are also one or more objects that express information about groups of people. The other components the aggregation system 970, profile aggregators 990A-B and a comparison module 988, may also execute on the same system as Discovery Server 1220, and communicate with one or more Notes clients or server through a network such as that illustrated in FIG. 3.

Once the group definition 984 has been defined, and the relevant user profiles compiled, the system 970 uses a set of aggregators 990A-N to combine the like properties from the chosen user profiles into the aggregated profile representing the group. The types of aggregation depend on the types of properties being aggregated. In the illustrative embodiment, the discovery server 1220 contains the knowledge about different data types and how to perform the aggregations thereon, and how to display the results in the group profile 992. Once the set of objects for aggregation has been chosen, e.g. the Discovery Server user profile format, the system uses a set of profile aggregators 990 to combine the like properties from the chosen profiles into the aggregated property. The types of aggregation depend on the types of properties being aggregated. Text properties may be compiled into lists. For example, all job titles from the individual profiles could be listed, with duplicates removed. Numerical properties may be summed, averaged, etc. as appropriate for the meaning of the data. For example, each person's affinities may have weight values. The aggregator for affinities may take the weight values for a particular affinity and sum them. The list of sums for all the aggregated affinities would demonstrate the nature and degree of expertise that the group has for those categories of information. Other types of data may require other techniques.

Aggregated property values may also be ordered in ways appropriate to the data, to further convey meaning to the information. For example, a list of cities where the individuals' offices are located could be sorted by size descending, to show quickly where most people are located, or, the list of affinity sums displayed by value, for example in bar graph format as illustrated in FIG. 14, clearly indicates where the group's expertise strengths and weaknesses lay.

As shown in FIG. 18, the resultant output of the aggregators 990A-N is the group profile 992 that represents the properties of the group and so provides a quick and easy way to understand the nature and essence of the group, without having to reference and evaluate each of the individual members. The aggregated group profile 992 easily provides a “big picture” view of the attributes of the group members as a single entity unto itself. With a location property, for example, the user of the aggregate gets an immediate sense of where the group “is.” For areas of expertise, for example, the user sees what the group “knows”, such as illustrated in bar graph format of FIG. 14. At this point, the group profile 992 provides useful information as to the nature of the set of object that define the group and their collective attributes and affinities. Optionally, the aggregated group profile 992 may be compared to one of a plurality of predefined ideal profiles 995 or templates. Such profiles may be stored in the same database in which the user profiles are stored and may represent an idealized standard against which the group profile 992 is compared. The differences, particularly any deficiencies, with the group profile may then be reported for analysis, illustrated as a Kgap “profile 993 in FIG. 18.

In the illustrative body of the invention, the attributes that are to be aggregated by the property collector, e.g. the Discovery Server 1220, are inherently determined by the mappings of information, such as name, address, employee identification information, phone numbers, etc. from multiple difference sources to the defined user profile within Discovery Server 1220. Alternatively, system 970 may allow the definition of the aggregation to be created automatically or manually. In the automatic mode, the system 970 either inherently chooses the attributes to be aggregated through the mappings to the user profile, as in the illustrative embodiment, or selects the attributes to be aggregated from a plurality of predefined definitions. In the manual mode, users of the system choose which objects to aggregate. With either automatic or manual modes, the aggregation system itself contains the knowledge about how to perform the aggregation, and how to display the results. The difference between automatic and manual versions has only to do with the way objects are chosen for aggregation. Some valuable uses of manually created group Profiles might include:

Create an “ideal” set of properties, especially affinities, to be used as a model.

Propose teams of people by building the desired set of properties, especially affinities. Keep adding people until the set is right.

Create a composite of individuals in order to identify knowledge gaps within the set. This could be large aggregates in order to expose weaknesses within different communities.

Create composites to expose places where skills are overdeveloped, e.g. why do we have so many experts in Pascal coding?

Manually duplicate existing group profiles using the groups members and use that composite to subtract people who don't weaken the group's expertise in significant ways, e.g. use this to deconstruct groups so that resources can be shared elsewhere.

In FIG. 18 the system flow paths for automatic and manual aggregation are labeled appropriately on the diagram.

In addition to aggregating individual profiles, the system can also include in the aggregation process existing Group profiles. Thus, the system can further aggregate existing aggregates, providing a way to gain a sense of group characteristics at higher and higher levels.

Referring to FIG. 19, the process begins with Lotus Notes Mail Agent 230 receiving a request for a Kgap analysis from the recipient of a meeting request, as illustrated by decisional step 1900. Upon receipt of such request, mail agent 230 forwards to discovery server 1220, which is presumed to be accessible via a network, the current list of meeting participants, as illustrated by procedural step 1902. In the illustrative embodiment, the list of meeting participants serves as the group definition, and is supplied in a format which enables discovery server 1220 to access the respective user profiles 986 with the participant information. Discovery server 1220 then uses the participant identifiers, for example, the Notes or e-mail address of a participant as a handle into the user profile database and retrieves each of the respective user profiles, as illustrated by procedural step 1904. The retrieved collection of user profiles represents the members of the defined group, i.e., the meeting. A plurality of profile aggregators 990A-N then compare similar data types from each of the group of user profiles in an attempt to provide an aggregate group profile, as illustrated by procedural step 1906. The results of each aggregation process are compiled into a profile which is then compared to one of a plurality of predefined ideal profiles for templates, as illustrated by procedural step 1908. Such predefined templates may be stored in the same database in which the user profiles are stored and represent an ideal set of data values against which the group of profile is compared. For example, given the exemplary scenario of a meeting, a group profile for a sales meeting would require a different ideal group profile than the group profile for an engineering/development meeting, each of which, in turn, may require a different group profile of a cross disciplinary team meeting.

The discovery server 1220 determines from the comparison of the group profile 998 with the ideal group profile 995 whether any specific data type, i.e., expertise area is deficient, as illustrated by decisional step 1910. If so, discovery server 1220 utilizes the location data from the group profile, or another data type within the group profile, and performs a search of the existing user profiles for the profile of an individual or multiple individuals whose affinities, as defined in their respective user profiles, could possibly supplement the deficiencies in the group profile, as illustrated by decisional step 1912. The results of the comparison of the group profile with the idealized profile are supplied back to mail agent 230, in the form of a Kgap profile 993, along with the user information and profile of one or more suggested additional meeting participants, as illustrated by procedural step 1914. Mail agent 230 then presents this information to the viewer as illustrated in FIG. 15 for the viewer's consideration, as previously described.

Discovery Server Application

The Lotus-Discovery Server 1220, commercially available from International Business Machines Corporation, is a knowledge management tool that extracts, analyzes and categorizes structured and unstructured information to reveal the relationships between the content, people, topics and user activity in an organization. The Lotus Discovery Server 1220 automatically generates and maintains a Knowledge Map (K-map) to display relevant content categories and their appropriate hierarchical mapping that can be searched or browsed by users. The Lotus Discovery Server also generates and maintains user profiles and tracks relevant end-user activities, identifying those individuals who may be subject matter experts. Through such expertise profiling, and content discovery the server uncovers organizational know-how in terms of where things are, who knows what, what is relevant, and which subjects generate the most interest and interactivity.

Referring to FIGS. 17-18, the of Discovery Server 1220 can be utilized to synthesize affinities for areas of expertise for users. Such affinity data may be stored in a separate memory or database 982C, as illustrated in FIG. 18. The other sources of information 982A-B and 982C may be supplied to the Discovery Server 1220 using data mapping techniques. Specifically, information such as name, address, employee identification information, phone numbers, etc. may be mapped from multiple difference sources, typically databases, to a defined user profile within Discovery Server 1220, which then adds any affinity profiles to the user profiles. Such user profiles 986A-C may be stored in a database accessible by Discovery Server 1220. The manner in which the Discovery Server 1220 collects information and synthesizes affinities associated with users in described hereinafter, such description being for exemplary purposes and not meant to be limiting.

The Discovery Server 1220 can analyze the content of a collection of documents, create clusters of related documents, and then organize those clusters into a tree of categories called a taxonomy. The Discovery Server 1220 also indexes document content, and provides a user interface that supports both full-text and taxonomy-based searching.

The process of finding and analyzing documents is called spidering, and the Discovery Server 1220 can spider a variety of document repositories, including file systems and collaborative applications, such as Lotus Notes or Microsoft Exchange. Once the taxonomy is created, the Discovery Server 1220 periodically scans for new documents, and assigns the new documents to a category based on their similarity to the documents that are already in the category.

The Discovery Server 1220 analyzes document usage patterns in order to associate people with categories. A person who frequently reads, writes, or responds to documents in a particular category is said to have an affinity for that category. The Discovery Server 1220 creates and maintains user profiles 986, and stores the affinities it has generated, or those retrieved from memory 982C, in conjunction with the user profiles 986. The Discovery Server's search interface supports affinity-based search, e.g. find people who have an affinity for “Java”.

The system architecture of the Discovery Server 1220 is described with reference to FIG. 17. The Discovery Server 1220 comprises spider modules 1260, full-text indexer 1262, taxonomy generator 1264, metrics system 1266 and web browser 1268. The spider modules 1260, also referred to herein as “spiders”, are responsible for “crawling” documents, from a number of sources including HTML web based document accessible through the Internet 1320, directories 1261, and files 1269, in order to extract content and convert the content into a normalized XML format. The normalized documents are then passed into subsystems 1262, 1264 and 1266 within Discovery Server 1220 and the results stored in the respective subsystem databases. A full-text indexer 1262 creates a searchable index of the keywords found in the normalized documents for storage in database 1263. Taxonomy generator 1264 places the normalized documents into an appropriate category for storage in database 1265. Metrics subsystem 1266 tracks and analyzes usage patterns and calculates affinities for storage in database 1267. A web browser 1268 may then be used by the user to view or search the taxonomy generated by the Discovery Server 1220.

The testing and performance of the Discovery Server 1220 are described, in the illustrative embodiment, with reference to the calculation of affinities. Affinities are maintained by the Metrics subsystem 1266 of the Discovery Server 1220. The Metrics subsystem 1266 collects information about the interactions between system entities such as people, documents, and categories. The interactions are inferred from the meta-data extracted from documents by the spiders 1263, or else from user interactions with the user interface of Discovery Server 1260. Information describing each interaction is stored as a record in a table of taxonomy database 1265, where each record may have a format similar to the following format:

| | | | | |
|---|---|---|---|---|
| Entity 1 | Interaction | Entity 2 | Value | Timestamp |
| | Type | | | |

The interactions between people and documents provide the raw data from which Metrics system 1266 calculates affinity values. These interactions appear in the Metrics database 1267 as records that may have a format similar to the following format:

| | Interaction | |
|---|---|---|
| Entity 1 | Type | Entity 2 |
| Person | is author of | Document |
| Person | Modified | Document |
| Person | Responded to | Document |
| Person | opened | Document |
| Person | created links to | Document |

Other tables in the Discovery Server system associate documents with categories, so that it is possible to associate each document interaction with a category. The value of a person's affinity is updated once per day, and the value of the affinity at time t may be found as follows:

Affinity(t)=Affinity(t−1)+σ(Wᵢ×Mᵢ)−Decay(t−1)

where Mi is the count of a particular interaction type for a person within a category since the last affinity update, and Wi is a weighting factor for that interaction type. Weighting factors may range between 0 and 1. The decay may be calculated as follows:

Decay(t−1)=0, if sum(Wi×Mi)>0

Decay(t−1)=0.01×Affinity(t−1), if sum(Wi×Mi)=0

Accordingly, a person's affinity value for a category decays at 1% per day for each day where the person shows no document activity in that category. When the affinity value for a person in a category exceeds a threshold, the system adds the category to the person's expertise profile. The system may notify the person about the update via e-mail, so that the person can manually update their expertise profile, if the suggested category is not appropriate or should be kept private.

Under normal usage the Discovery Server 1220 may run continuously, collecting and analyzing data over a long period of time, potentially years. The affinity values, for example, slowly build up as people work with documents, taking, possibly, months for a person's activity to accumulate to the point where an affinity was detected.

Although the illustrative embodiment of the invention has been disclosed, within the environment of electronic mail communications and with the use of the Lotus Discovery Server 1220 as the primary mechanism for property collection, it will be apparent to those skilled in the art that any object parameters and any system for compiling profiles of objects, not necessarily just people, can be used with the system 970 to obtain a group profile using the aggregation technique described herein.

A software implementation of the above-described embodiments may comprise a series of computer instructions either fixed on a tangible medium, such as a computer readable media, e.g. diskette 142, CD-ROM 147, ROM 115, or fixed disk 152 of FIG. 1A, or transmittable to a computer system, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. Further, many of the system components described herein have been described using products from International Business Machines Corporation. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results. Such modifications to the inventive concept are intended to be covered by the appended claims.

What is claimed is:

1. In a computer system a method comprising:
(A) defining a plurality of object profiles having data attributes;
(B) aggregating selected data attributes from the plurality of object profiles; and
(C) generating a group profile having data attributes representative of a group of the plurality of object profiles.

2. The method of claim 1 further comprising:
(D) providing the group profile to a requester for review.

3. The method of claim 1 wherein (B) comprises:
(B1) determining which of the data attributes in the object profiles are to be aggregated.

4. The method of claim 1 wherein (B) comprises:
(B1) determining which of the plurality object profiles are to be aggregated to form the group profile.

5. The method of claim 1 further comprising:
(D) comparing the group profile with an idealized profile; and
(E) generating a comparison profile representing differences between the group profile and the idealized profile.

6. The method of claim 1 further comprising:
(F) searching for a supplementary object profile the having a data attribute that compensates for a deficiency in the comparison profile; and
(G) providing the comparison profile and any supplementary object profile to a requestor for review.

7. The method of claim 1 wherein the plurality of object profiles further comprise affinity data and wherein (A) comprises:
(A1) identifying an affinity associated with an object as part of an object profile.

8. The method of claim 7 wherein (B) further comprises:
(B1) aggregating selected affinities from the plurality of object profiles, and wherein (C) further comprises:
(C1) generating a group profile having affinities representative of a group of the plurality of object profiles.

9. In a computer system operatively connectable to a network and capable of executing a communication process for sending and receiving electronic mail documents, a method comprising:
(A) defining a plurality of user profiles having data attributes;
(B) aggregating the plurality of user profiles to generate a group profile having common data attributes representative of the group of user profiles; and
(C) providing the group profile to a requester for review.

10. The method of claim 9 further comprising:
(D) comparing the group profile with an idealized profile; and
(E) generating a comparison profile representing differences between the group profile and the idealized profile.

11. The method of claim 9 further comprising:
(F) searching for a supplementary user profile having an attribute that compensates for a deficiency in the comparison profile; and
(G) providing the comparison profile and any supplementary user profile to a requestor for review.

12. The method of claim 9 wherein the plurality of object profiles further comprise affinity data and wherein (A) comprises:
(A1) identifying an affinity associated with an object as part of an object profile.

13. The method of claim 12 wherein (B) further comprises:
(B1) aggregating selected affinities from the plurality of object profiles, and wherein (C) further comprises:
(C1) generating a group profile having affinities representative of a group of the plurality of object profiles.

14. A computer program product for use with a computer system, the computer program product comprising a computer useable medium having embodied therein program code comprising:
(A) program code for defining a plurality of object profiles having data attributes;
(B) program code for aggregating selected data attributes from the plurality of object profiles; and
(C) program code for generating a group profile having data attributes representative of a group of the plurality of object profiles.

15. The computer program product of claim 14 further comprising:
(D) program code for providing the group profile to a requestor for review.

16. The computer program product of claim 14 wherein (B) comprises:
(B1) program code for determining which of the data attributes in the object profiles are to be aggregated.

17. The computer program product of claim 14 wherein (B) comprises:
(B1) program code for determining which of the plurality object profiles are to be aggregated to form the group profile.

18. The computer program product of claim 14 wherein the plurality of object profiles further comprise affinity data and wherein (A) comprises:
(A1) program code for identifying an affinity associated with an object as part of an object profile.

19. The computer program product of claim 18 wherein (B) further comprises:
(B1) program code for aggregating selected affinities from the plurality of object profiles, and wherein (C) further comprises:
(C1) program code for generating a group profile having affinities representative of a group of the plurality of object profiles.

20. A computer data signal embodied in a carrier wave for use with a computer system, the computer program product comprising a computer useable medium having embodied therein program code comprising:
(A) program code for defining a plurality of object profiles having data attributes;
(B) program code for aggregating selected data attributes from the plurality of object profiles; and
(C) program code for generating a group profile having data attributes representative of a group of the plurality of object profiles.

21. An apparatus for use with a computer system, the apparatus comprising:
(A) means for defining a plurality of object profiles having data attributes;
(B) means for aggregating selected data attributes from the plurality of object profiles; and
(C) means for generating a group profile having data attributes representative of a group of the plurality of object profiles.

22. The apparatus of claim 22 wherein (B) comprises:
(B1) program logic for determining which of the data attributes in the object profiles are to be aggregated.

23. The apparatus of claim 14 wherein (B) comprises:
(B1) program logic for determining which of the plurality object profiles are to be aggregated to form the group profile.

24. The apparatus of claim 14 wherein the plurality of object profiles further comprise affinity data and wherein (A) comprises:
(A1) program logic for identifying an affinity associated with an object as part of an object profile.

25. The apparatus of claim 18 wherein (B) further comprises:
(B1) program logic for aggregating selected affinities from the plurality of object profiles, and wherein (C) further comprises:
(C1) program logic for generating a group profile having affinities representative of a group of the plurality of object profiles.

26. An apparatus for use with a computer system, the apparatus comprising:
(A) a property collector for receiving attribute data from at least one source and generating a plurality of object profiles therefrom;
(B) program logic for identifying at least some of the plurality of object profiles comprising a group definition; and
(C) at least one profile aggregator, responsive to the plurality of object profiles generated by the property collector and identified by the group definition, for aggregating the plurality of user profiles to generate a group profile having data attributes representative of the user profiles identified by the group definition.

27. The apparatus of claim 26 further comprising:
(D) program logic for providing the generated group profile to a requestor.
